(19) United States
(12) Patent Application Publication
(10) Pub. No.: US 2005/0287491 A1
(43) Pub. Date: Dec. 29, 2005

(54) Bi-laminate martix and method of use

(76) Inventor: Charles E. Slone, San Juan Capistrano, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 11/217,932

(22) Filed: Sep. 1, 2005

Related U.S. Application Data
(63) Continuation-in-part of application No. 10/802,187, filed on Mar. 18, 2004.

(51) Int. Cl. A61C 5/04

(52) U.S. Cl. 433/39

(57) ABSTRACT

A dental matrix apparatus provides a retaining surface for a filling material placed into a tooth preparation in a class II, III or IV restoration. The matrix is made up of a foil strip providing a window covered by an infrared light transparent film. A method provides for placement of the foil and film strip in contact with a tooth to be filled and shining UV light through the window in order to harden the filling material that abuts the strip.

### RELATED APPLICATIONS

This application is a continuation-in-part application of U.S. patent application Ser. No. 10,802,187, filed Mar. 17, 2004, entitled, Dental Matrix for a Class II, III or IV Restoration, currently pending and which is incorporated herein by reference. Your applicant also has pending further related applications including: U.S. Ser. No. 10,692,574, filed Oct. 24, 2003, entitled Matrix Wedge Restorative Dental System and Method of Use; and U.S. Ser. No. 291,192,522, filed Oct. 24, 2003, entitled Dual Handle Dental Matrix Strip; and U.S. Ser. No. 10,812,616, filed Mar. 29, 2004, entitled, Dental Hand Tool for Interproximal Dental Restorations.

### BACKGROUND

### FIELD OF THE PRESENT DISCLOSURE

This invention relates generally to apparatus for bounding dental preparations for fillings, and more particularly to a dental matrix of thin metal or plastic, able to slide between abutting teeth so as to be positioned for bounding a class II, III or IV restoration with minimum separation between the teeth and which is able to pass UV light for curing a filling material.

The following art defines the state of this field at this time:

Stark et al., U.S. Des. 253,191 describes a dental matrix design. Tofflemire, U.S. Pat. No. 3,145,472 describes a pre-contoured dental matrix band comprising: a strip of pliable material having an arcuate central portion and arms extending from the arcuate central portion, with the arms diverging relative to one another when the strip is flat; the strip having an inner surface; the strip having a pair of preformed elongated concavities in its inner surface which are spaced apart; each of the preformed concavities being substantially oval in face view, with the major axis of the oval extending generally lengthwise of the strip. Tofflemire, U.S. Pat. No. 3,305,928 describes a dental matrix band comprising: a strip of pliable material having an arcuate central portion and a pair of arms extending from the ends of the arcuate central portion, each arm defining a terminal tip at its outer end; the strip having inner and outer faces; a pair of traction instrument-engaging abutments provided on the terminal tips of the arms to extend at substantially right angles relative to the lengths of their respective arms; the abutments projecting laterally beyond at least one face of the strip, and being reinforced so that they will not be sheared off when traction force is exerted thereon; the terminal tip and abutment on one arm being independent and unsecured to the terminal tip and abutment of the other arm, whereby the arms may be selectively moved into parallel contacting relation with one another or the arms freely separated relative to each other; the abutments being defined by independent tubular ends on the tips of the strip that surround and embrace separate rods, the tubes being fixed to their respective rods. Eames, U.S. Pat. No. 3,842,505 describes a dental matrix band construction of the type including a central tooth-surrounding portion with arms formed at the opposite end of the tooth-surrounding portion. These arms are utilized for securing the band in position on a tooth. The central portion of the band defines a concave interior tooth-engaging surface because of a bend in the upper part thereof, the concavity extending between the top and bottom edges of the central portion. The bottom edge of the band defines a straight edge while the top edge of the band is curved between the respective junctures of the arms and central portion whereby the band is progressively wider from the junctures to the mid-point of the central portion. Franklin et al., U.S. Pat. No. 3,854,210 describes a matrix the end portions of which are provided with a common surface upon which are mounted a plurality in the longitudinal ribs. A retainer for use in the engagement of the ribs of the above matrix after the latter is placed in the desired position around the peripheral area of a tooth. Lazarus, U.S. Pat. No. 4,781,583 describes a dental matrix band for engaging around a tooth comprising a plastic sheet member which includes a straight winding portion which can be wound into a coil and a curved tooth engaging portion which is wrapped around to form a tooth engaging band. A lock loop having inner and outer legs is engaged onto overlapping portions of the band to hold the band in position. The locking loop has interior notches which form a gingival inwardly directed bend and tooth contacting point and an elongated gingival open area to provide band's diametric adjustability prior to seating matrix on a tooth, as well as a crimp structure for crimping the occlusal edge of the band to form an occlusal concavity. The coil may be conical and polygonal in shape to more accurately receive a winding burr of a winding tool. The coil is rotatable to tighten the band around a tooth. A retaining end of the sheet material which is on the inside of the band is provided with an elongated laminate to reinforce the plastic band underlying the rotatable coil which is adjacent said retaining end. The coil is wound against this supporting, reinforced area which prevents underlying band from collapsing and being “wrapped-under” by coil which pulls the matrix material through the lock loop with winding of the coil. Von Weissenfluh, U.S. Pat. No. 4,824,365 describes a matrix consisting of a thin flexible strip of plastic comprising a loop to be placed around the tooth to give the desired shape to the filling material. It is permanently connected to an annular tightener made of material permanently deformable by pressure with the fingers and dentist's forceps, for example, of annealed aluminum sheet. It exhibits, in the front, a slit through which pass the two terminal extensions of flexible strip and, in the back, tabs between which are permanently fastened the ends of said terminal extensions of said strip, so that by compressing said annular tightener it determines the slipping of slit like a slider on the extensions of the strip, the narrowing of loop and the perfect adherence of the loop of the strip to the tooth. Summer, U.S. Pat. No. 5,505,618 describes a tooth spacer comprising an elongated body having two opposite side edges extending between gingival and occlusal edges. A recessed or thin central portion of the body extends from the gingival edge toward the occlusal edge. The recessed central portion is sufficiently thin so that it may be inserted between the interproximal surfaces of two adjacent teeth while minimizing any wedging of the teeth apart. McKenna et al., U.S. Pat. No. 6,220,858 describes an apparatus for placement of light curable dental fillings. The apparatus includes a matrix formed of light transparent material and shaped to conform to the natural contour of a tooth in the interproximal zone. The matrix is thinned in its central regions to permit a filling to be made which has close contact with an adjacent tooth. A light transparent wedge has also been invented which selectively conducts light to the base of the tooth preparation and which can be used to conduct light interproximally which light has been applied at either end of the wedge. A clamp has been invented for use with the wedge and/or matrix or for use independently of these devices. The clamp is formed to fit over the top portion of the wedge to enhance engagement against the tooth over previous clamps, which are prevented from extending over the tooth by engagement against the top of the wedge.

Our prior art search describes dental matrix bands, a matrix with retainer, an adjustable plastic film matrix, a dental matrix in a flexible strip with tightener connected to it, a tooth spacer, and an apparatus for placement of dental fillings, but does not teach the use of a dual layer matrix band structurally capable of being inserted between tightly abutting adjacent teeth yet which provides a window positioned so as to be able to be moved to that location between two adjacent teeth wherein contact between the teeth occurs, and wherein the window is covered by a very thin film so that a tight contact is achieved in a class II, III, or IV dental restoration. The present invention fulfills these needs and provides further related advantages as described in the following summary.

### SUMMARY

The present method uses a dental matrix band to support a filling material placed into a tooth in a class II, III or IV restoration, i.e., where a portion of the filling material abuts the adjacent tooth. In such a situation it is desirable and, indeed, necessary to obtain a tight contact between the filled tooth and its adjacent tooth. This is nearly impossible to achieve since the matrix band itself separates the two teeth during the restoration and when removed, the space that had been taken up by the band is now a separating space between the teeth. This problem is overcome by the present apparatus which uses a matrix band fabricated from a thin sheet stock of stainless steel, for example for strength, plus a very thin film mounted in a window in the steel band and positioned where the teeth contact. This provides two benefits: first, enabling the band to be forced between the teeth without deforming or buckling, and second, enabling the two teeth to assume very close contact during the placement and hardening of the filling material. Furthermore, the film is able to compress and bulge into the window to allow even more intimate contact between the two teeth. The sheet stock is made of a material such as a spring temper steel foil that may deform when being inserted, and yet will then resume its original shape after placement. This provides the advantage of a smooth outer surface to the filler material, which is most difficult to achieve in post-hardening steps because access is obstructed by the adjacent tooth. A secondary function of the window in the matrix strip is that it allows UV light to pass so as to improve the hardening and shorten the hardening time of the dental filling material.

This disclosure teaches certain benefits in construction and use which give rise to the objectives described below.

A primary objective inherent in the above described apparatus and method of use is to provide advantages not taught by the prior art.

A further objective is to provide such an invention capable of being positioned with relative ease between abutting teeth, one of which is prepared for a filling operation.

A still further objective is to provide such an invention capable of being moved bilaterally to position a contact window at the contact area between a tooth to be filled and its immediate neighbor tooth for a class II, III or IV type restoration.

A yet further objective is to provide such an invention capable of providing an improved broad and tight contact.

Other features and advantages of the described apparatus and method of use will become apparent from the following more detailed description, taken in conjunction with the accompanying drawings, which illustrate, by way of example, the principles of the presently described apparatus and method of its use.

### BRIEF DESCRIPTION OF THE DRAWINGS

The accompanying drawings illustrate at least one of the best mode embodiments of the present apparatus and method of it use. In such drawings:

FIG. 1 is a side elevational view of the presently described apparatus;

FIG. 2 is a section view thereof taken along line 2-2 in FIG. 1;

FIG. 3 is a partial view of one end of the apparatus showing the relationship between foil and film layers; and

FIG. 4 is a perspective view showing a best use thereof.

### DETAILED DESCRIPTION

The above described drawing figures illustrate the apparatus described herein and its method of use in one best mode embodiments. Those having ordinary skill in the art may be able to make alterations and modifications to what is described herein without departing from its spirit and scope. Therefore, it should be understood that what is illustrated is set forth only for the purposes of example and that it should not be taken as a limitation in the scope of the present apparatus and method of use.

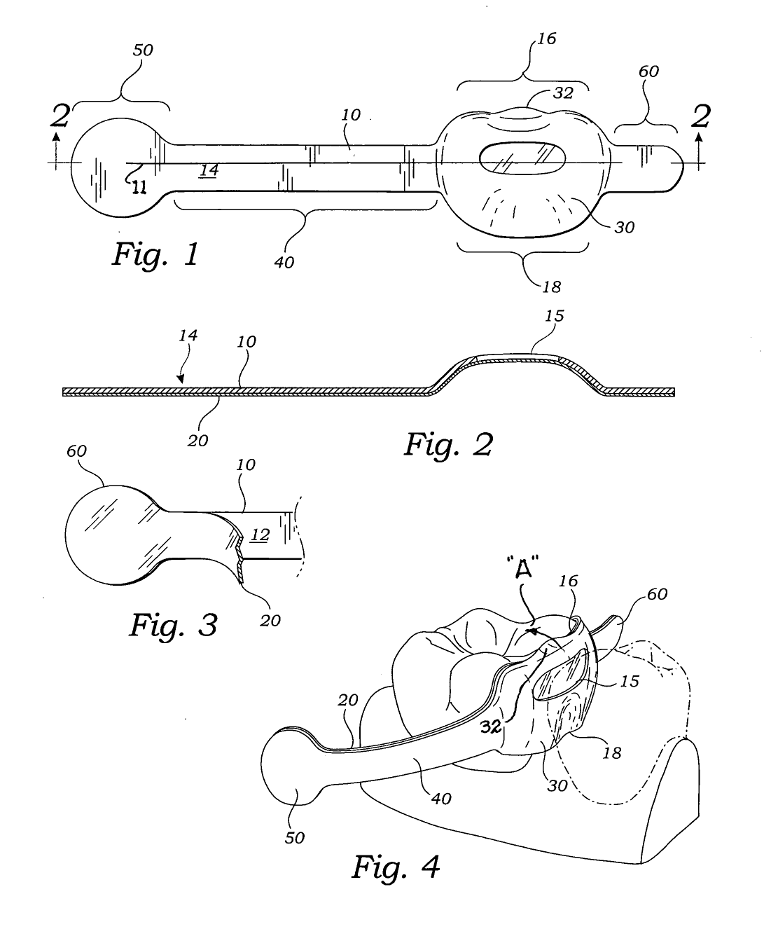

The presently described apparatus is a dental matrix apparatus, also referred to as a band or strip, for defining a surface of a filling material that is placed into a tooth preparation in a class II, III or IV restoration wherein the filling material when hardened forms a portion of the side wall of the restored tooth. The apparatus is made up of a foil 10, having the shape of an elongated strip and is made of a stiff flexible, structural material such as stainless steel of between 0.0005 and 0.003 inches thickness which has a contact surface 12 on one side and a back surface 14 on the other side. This foil 10 further has a top peripheral edge 16, and a bottom peripheral edge 18 as shown in FIG. 1. A horizontal axis 11 extends between the peripheral edges 16 and 18 and is generally parallel to them. The foil 10 has a window 15 therein which is also positioned between the peripheral edges 16, 18 and which is extensive between the contact surface 12 and the back surface 14 so that the window 15 is able to be aligned with a contacting surface of an adjacent tooth 6.

Adhering to the contact surface 12 due to, for instance, a bonding agent, and covering the window 15, is visible light transparent film 20, of between 0.00005 and 0.0010 inches thickness. This film 20 is best seen in FIGS. 2 and 3, the latter showing that the film 20 is a distinguishable layer relative to the foil 10. The film 20 may be made of several engineering plastics such as polycarbonate, polyester and polyethylene but it must be of such structural integrity as to withstand relatively high pressure because a filling material being packed into a tooth preparation may exert high forces on the restraining surfaces around it. The window 15 is placed in a tooth contacting portion 30 of the apparatus as shown in FIG. 1. Extending laterally to one side of the tooth contacting portion 30 is a strip portion 40 which terminates with an enlarged portion 50 of sufficient size for tightly gripping with the fingers. Extending laterally in opposition to the strip portion 40 is a shorter tab portion 60.

It is stressed that the thickness ranges of the foil 10 and film 20 are critical to the successful use of the apparatus. The total material thickness (foil plus film) must be such as to slide between tightly abutting teeth and yet have a strength capable of such engagement and also for securing the filling material when under pressure of compaction. It has been found that the present materials and their thicknesses are able to complete this mission although such a combination has not been known or used in this manner previously.

The contacting portion 30 provides, along the top peripheral edge, a relatively high point 32 centered on the window 15 such that when the apparatus assumes its concave shape as shown in FIG. 4, the material around the high point 32 tends to fold over in the direction shown by arrow “A” in FIG. 4. this folding over of the high point 32 and surrounding material helps to round-off the upper edge of the filling material as desired and necessary for an acceptable formation of the filling material.

In use, the apparatus is positioned in a horizontal orientation, i.e., the horizontal axis 11 is held in an approximate horizontal attitude with the strip portion 40 positioned adjacent to the contact surfaces between a tooth 5 which has been prepared for filling and an adjacent tooth 6. With the apparatus held tightly in tension by gripping the enlarged portion 50 with one hand, and the tab portion 60 with the other hand, the strip portion 40 is pressed between the teeth 5 and 6 with the contact surface 12 facing tooth 5, the tooth to be filled. Actually, the film 20 will be in physical contact with tooth 5. Next, the apparatus is moved laterally until the tooth contacting portion 30 is positioned as shown in FIG. 4. To assure proper positioning, the apparatus may be moved laterally in either direction until the tooth contacting portion 30 is correctly positioned. The apparatus has a tendency to take a concave shape as shown in FIG. 4. This is achieved by heat treating the foil so that it attempts to assume the concave shape when released, i.e., a spring condition; or by bonding the film 20 to the foil 10 with the film in a stretched condition at the time of bonding. The film 20 thereafter tends to resume its non-stretched condition and thereby pulls the foil 10 into the concave shape. With the apparatus in position, the tooth 5 may now receive a filling material and it may be hardened by a UV lamp. The window 15 allows the filling material that is in intimate contact with the apparatus to receive UV light directly through the window. This is important because it is the surface of the filling material that is in contact with the apparatus that must be fully hardened so as to make a proper contact with the other adjacent tooth 6 after the apparatus has been removed. It is well known that UV light cannot travel through opaque materials so that to enable such light to contact the filling material directly is a significant advance in dentistry.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

1. A dental matrix apparatus for defining a surface of a filler material placed into a tooth preparation in a class II, III or IV restoration, the apparatus comprising: a foil of a stiff flexible, structural material and having a contact surface, a back surface, a top peripheral edge, and a bottom peripheral edge, a horizontal axis of the apparatus extending between the peripheral edges and generally parallel thereto, the foil providing a tooth contacting portion having a window enclosed on all sides by the foil, the window positioned between the peripheral edges and extensive between the contact surface and the back surface; and, fixedly adherent to the contact surface and covering the window, a light transparent film of lesser thickness than the foil.

2. The dental matrix apparatus of claim 1 wherein the foil is between 0.0001 and 0.003 inches in thickness.

3. The dental matrix apparatus of claim 1 wherein the film is between 0.00005 and 0.0001 inches in thickness.

4. The apparatus of claim 1 wherein the window is elongate in the direction of the horizontal axis.

5. The apparatus of claim 1 wherein the top peripheral edge provides a relatively high point centered on the window.

6. The apparatus of claim 1 further comprising an elongate strip portion integral with the tooth contacting portion and extensive laterally therefrom in the direction of the horizontal axis.

7. The apparatus of claim 6 wherein the strip portion terminates at an integral enlarged portion.

8. The apparatus of claim 1 further comprising an elongate tab portion integral with the tooth contacting portion and extensive in the direction of the horizontal axis in a position laterally opposing the strip portion.

9. The apparatus of claim 1 wherein the foil is of stainless steel with a spring temper and formed with a concave shape.

10. The apparatus of claim 1 wherein the film is one of: polycarbonate, polyester, and polyethylene.

11. The apparatus of claim 1 wherein the film is in tension in the direction of the horizontal axis.

12. The apparatus of claim 1 wherein the contact surface is generally concave.

13. The apparatus of claim 1 wherein the film fully covers the contact surface of the foil.

14. A method of providing a retaining surface for a class II, III or IV tooth restoration comprising the steps of: positioning a matrix band of a foil layer and a film layer in a horizontal orientation with a strip portion of the band positioned adjacent to contacting surfaces between a prepared tooth and an adjacent tooth; gripping the band by an enlarged portion with one hand, and a tab portion with the other hand to hold the strip portion in tension, pressing the strip portion between said teeth with a contact surface of the band facing the prepared tooth and with the film layer in contact with the prepared tooth; moving the band laterally between the teeth until a tooth contacting portion of the band is positioned against the prepared tooth; compacting a filling material into the prepared tooth and against the band; hardening the filling material with a UV light beam including projecting the UV light beam through a window in the band.
